(19) United States
(12) Patent Application Publication
(10) Pub. No.: US 2019/0030932 A1
(43) Pub. Date: Jan. 31, 2019

(54) INKJET PRINTER

(71) Applicant: Roland DG Corporation, Hamamatsu-shi (JP)

(72) Inventor: Tsutomu TAKENOUCHI, Hamamatsu-shi (JP)

(21) Appl. No.: 16/049,931

(22) Filed: Jul. 31, 2018

(30) Foreign Application Priority Data
Jul. 31, 2017 (JP) 2017-147808

(51) Int. Cl. B41J 25/00; B41J 2/14

(52) U.S. Cl. CPC B41J 25/001; B41J 2/14

(57) ABSTRACT

A printer includes a base including a platen on which a recording medium is placed, a carriage provided on the base and movable in a main scanning direction Y, an ink head mounted on the carriage and including a nozzle to eject ink onto the recording medium, and a main body case attached to the base and including a right upper wall located above the carriage. The right upper wall has a through hole that overlaps with a movement path of the carriage as viewed in a plan view, and an accommodation container that opens upward is removably attached in the through hole.

### CROSS REFERENCE TO RELATED APPLICATIONS

This application claims the benefit of priority to Japanese Patent Application No. 2017-147808 filed on Jul. 31, 2017. The entire contents of this application are hereby incorporated herein by reference.

### BACKGROUND OF THE INVENTION

### 1. Field of the Invention

The present invention relates to an inkjet printer.

### 2. Description of the Related Art

Conventionally, inkjet printers, which perform predetermined printing on a recording medium by an inkjet method, are known. An inkjet printer includes a base having a platen on which a recording medium is placed, a carriage provided on the base, an ink head mounted on the carriage, and a main body case attached to the base. In such an inkjet printer, maintenance is performed on the ink head, the carriage, and other elements, periodically, such as when a failure occurred around the ink head or carriage.

Conventionally, when maintenance is performed on component elements mounted on the carriage including the ink head, a portion of the main body case, such as a case portion located above the carriage, has to be removed. Usually, because the case portion is attached to the base with a relatively large number of screws or the like, it takes a relatively long time to remove it. Even when maintenance time has not come yet, the case portion has to be removed similarly to the above when, for example, the user wants to check the condition of a component part mounted on the carriage. In addition, an operator often handles a large number of attachments and accessories (which are hereinafter referred to as “attachments, etc.”) including pinch rollers, a media clamp, a cutter and instruction manuals while using an inkjet printer. However, conventional inkjet printers have no space for storing the attachments, etc. properly, and the operator has to pay significant attention to management of the attachments, etc.

### SUMMARY OF THE INVENTION

Preferred embodiments of the present invention provide inkjet printers that allow easy access to a carriage and easy management of attachments, etc.

An inkjet printer according to a preferred embodiment of the present invention includes a base including a platen on which a recording medium is placed; a carriage provided on the base and movable in a main scanning direction; an ink head mounted on the carriage and including a nozzle to eject ink onto the recording medium; and a main body case attached to the base and including an upper wall located at least above the carriage. The upper wall has a through hole that overlaps with a movement path of the carriage as viewed in a plan view, and an accommodation container including a bottom wall and a side wall extending upward from a peripheral edge of the bottom wall and opening upward is removably provided in the through hole.

According to a preferred embodiment of the present invention, the through hole extends through the upper wall of the main body case, and the accommodation container is removably provided in the through hole. The through hole preferably is located at a position that overlaps with the movement path of the carriage as viewed in a plan view. Thus, when the accommodation container provided in the through hole is removed at the time of maintenance or the like, an operator is able to check the conditions of components or elements, such as the ink head, mounted on the carriage, through the through hole, and is able to easily access the components or elements through the through hole. In addition, because the accommodation container provided in the through hole opens upward, the operator is able to easily manage the attachments, etc. and is able to easily access the attachments, etc. by accommodating them in the accommodation container.

According to preferred embodiments of the present invention, it is possible to provide inkjet printers that allow easy access to a carriage and easy management of attachments, etc.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printer according to a preferred embodiment of the present invention.

FIG. 2 is a front view of a printer according to a preferred embodiment of the present invention.

FIG. 3 is a front view of a principal portion of a printer according to a preferred embodiment of the present invention.

FIG. 4 is a rear view of a printer according to a preferred embodiment of the present invention.

FIG. 5 is a plan view of a printer according to a preferred embodiment of the present invention.

FIG. 6 is a bottom view of a printer according to a preferred embodiment of the present invention.

FIG. 7 is a left side view of a printer according to a preferred embodiment of the present invention.

FIG. 8 is a right side view of a printer according to a preferred embodiment of the present invention.

FIG. 9 is a right side view of a portion of the printer according to a preferred embodiment of the present invention.

FIG. 10 is a perspective view, illustrating the structure around a through hole according to a preferred embodiment of the present invention.

FIG. 11 is a plan view, illustrating the structure around a through hole according to a preferred embodiment of the present invention.

FIG. 12 is a plan view of an accommodation container according to a preferred embodiment of the present invention.

FIG. 13 is a side view of an accommodation container according to a preferred embodiment of the present invention.

FIG. 14 is a front view of an accommodation container according to a preferred embodiment of the present invention.

### DETAILED DESCRIPTION OF THE PREFERRED EMBODIMENTS

Description is hereinafter made of inkjet printers according to preferred embodiments of the present invention with reference to the drawings. It should be understood that the preferred embodiments described herein are not intended to particularly limit the present invention. The members and elements having the same functions are designated by the same reference numerals and redundant descriptions are omitted or simplified as appropriate.

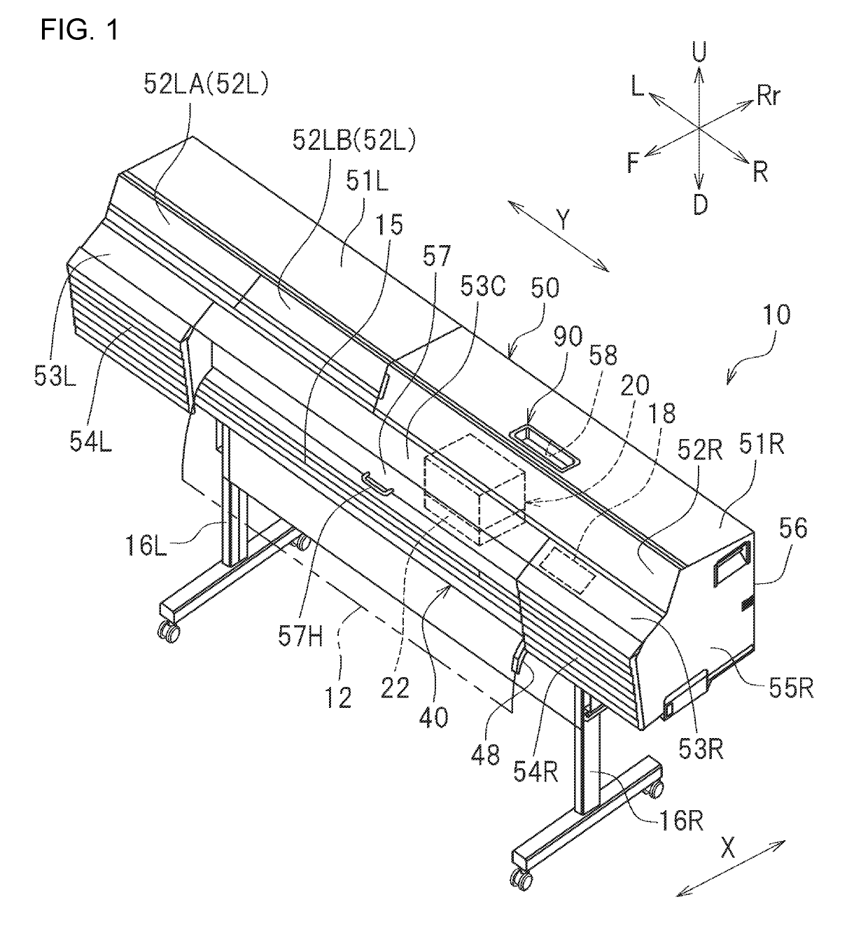

FIG. 1 is a front view, illustrating an inkjet printer (which is hereinafter referred to as “printer”) 10 according to a preferred embodiment of the present invention. As shown in FIG. 1, the printer 10 performs printing on a recording medium 12. The recording medium 12 is recording paper, for example. However, the recording medium 12 is not limited to recording paper. For example, the recording medium 12 may be a sheet-shaped medium, such as a resin sheet. In the present preferred embodiment, the recording medium 12 is in a roll form, for example.

In the following description, left, right, up and down mean left, right, up and down, respectively, seen from an operator in front of the printer 10. The direction from the printer 10 toward the operator and the direction away from the operator are defined as forward and backward, respectively. The symbols F, Rr, L, R, U and D in the drawings represent front, rear, left, right, up and down, respectively. An ink head unit 20, which is described later, is movable to the right and left. The recording medium 12 is transportable forward and backward. In the present preferred embodiment, a direction in which the ink head unit 20 moves is referred to as “main scanning direction Y,” and a direction in which the recording medium 12 is transported is referred to as “sub-scanning directions X.” Here, the main scanning direction Y corresponds to a right-left direction, and the sub-scanning direction X corresponds to a front-back direction. The main scanning direction Y and the sub-scanning direction X are perpendicular to each other. However, the main scanning direction Y and the sub-scanning direction X are not particularly limited, and may be set as appropriate based on the configuration of the printer 10 or the like.

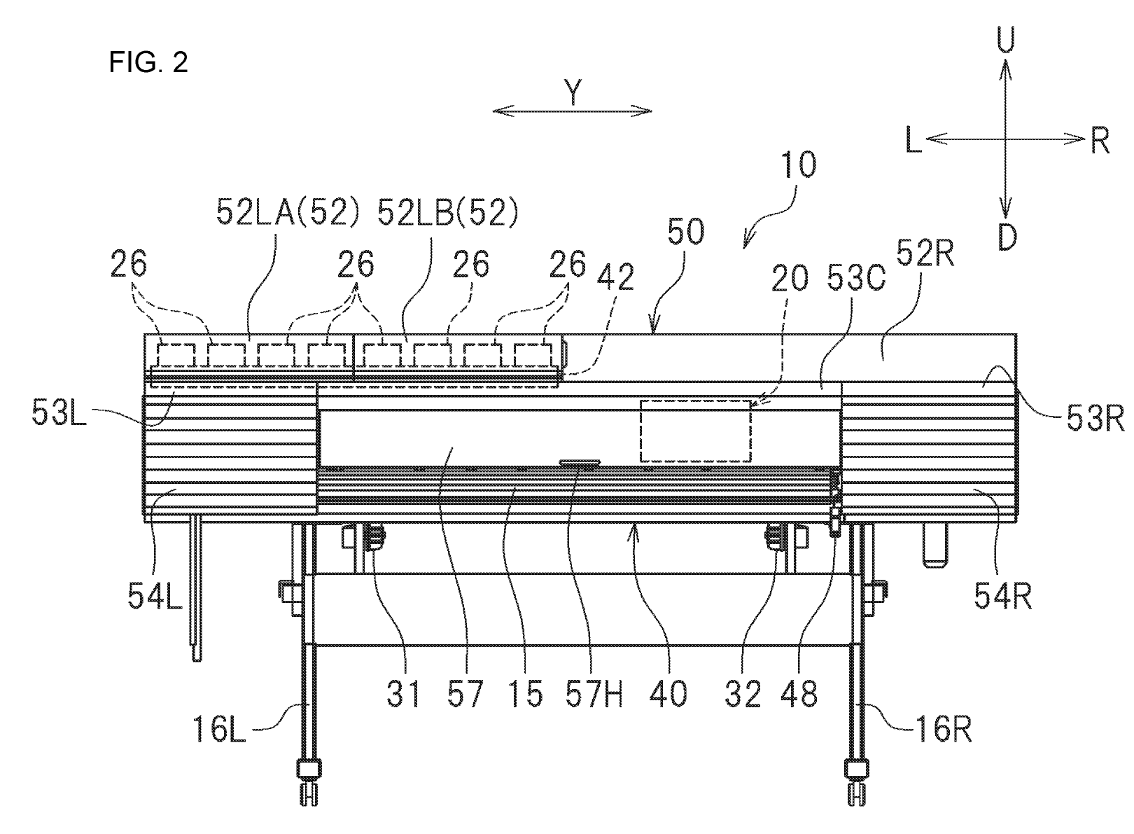

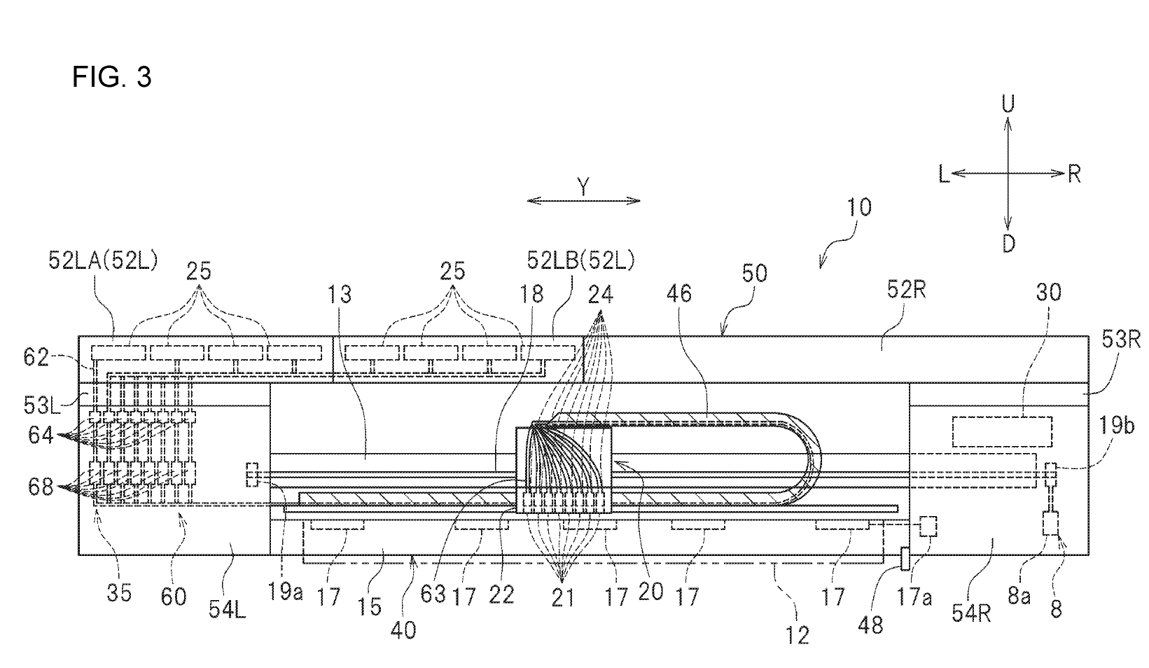

As shown in FIG. 1, the printer 10 includes a base 40, a main body case 50, a right leg portion 16R, a left leg portion 16L, an ink head unit 20, and cartridge holders 26 (refer to FIG. 2). The base 40 extends in the main scanning direction Y. The base 40 includes a platen 15. The main body case 50 is attached to the base 40. As shown in FIG. 2, the right leg portion 16R and the left leg portion 16L are attached to a lower portion of the base 40. The right leg portion 16R and the left leg portion 16L support the base 40. The ink head unit 20 is provided on the base 40. The ink head unit 20 is located inside the main body case 50. The ink head unit 20 is located above the platen 15. As shown in FIG. 3, the ink head unit 20 includes a carriage 22 and ink heads 24.

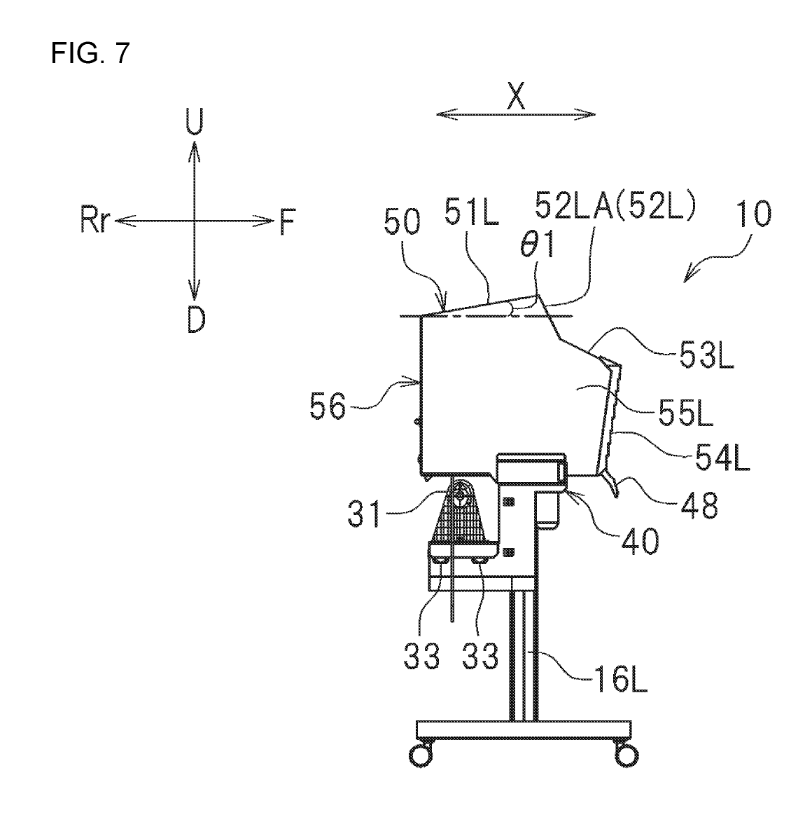

As shown in FIG. 1, the main body case 50 includes a left upper wall 51L, a right upper wall 51R, a first left front wall 52L, a first right front wall 52R, a second left front wall 53L, a central wall 53C, a second right front wall 53R, a left front cover 54L, a right front cover 54R, a left side wall 55L (refer to FIG. 7), a right side wall 55R, and a rear wall 56.

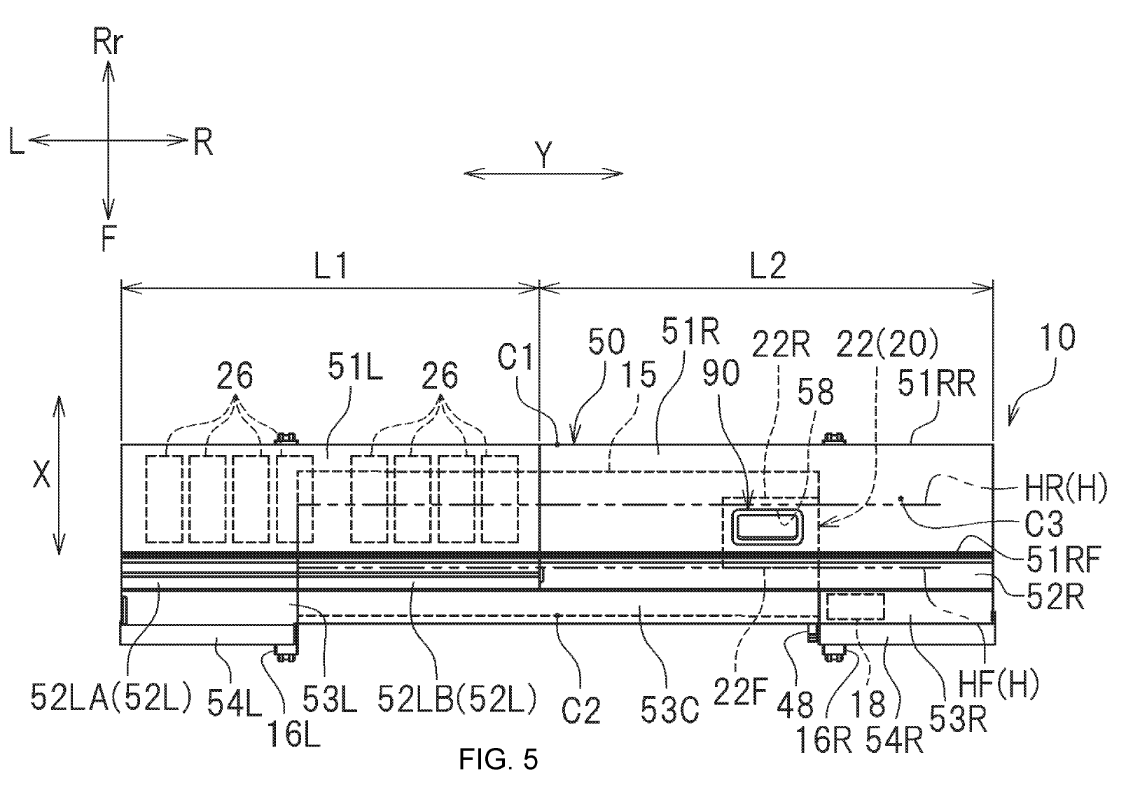

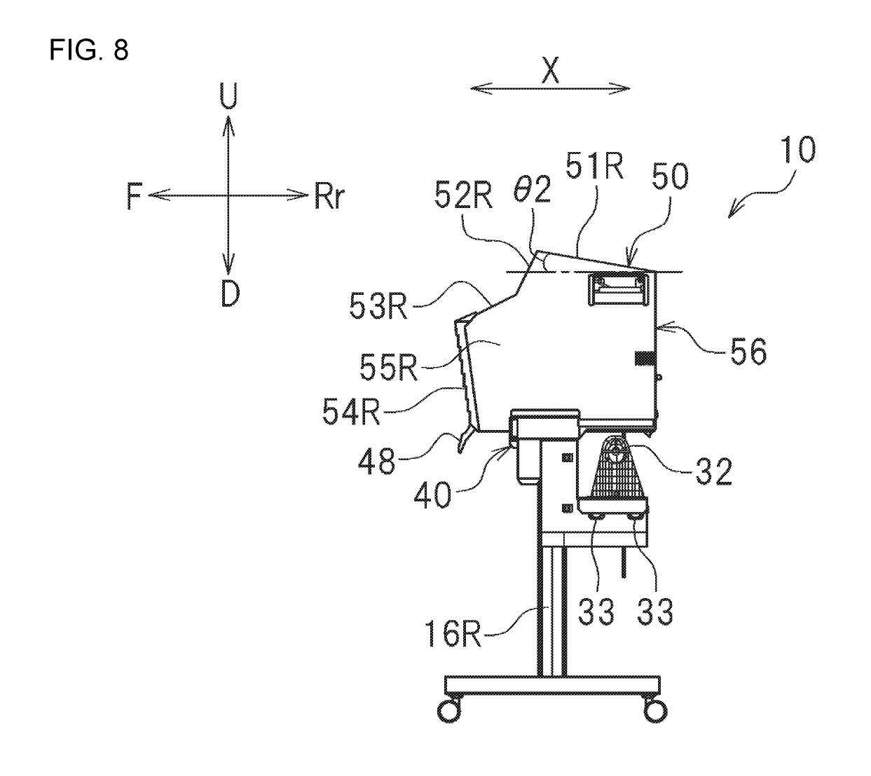

As shown in FIG. 1, the left upper wall 51L and the right upper wall 51R are located above the base 40. The left upper wall 51L and the right upper wall 51R are located above the carriage 22. The left upper wall 51L is located to the left of the right upper wall 51R. The left upper wall 51L and the right upper wall 51R extend in the main scanning direction Y. As shown in FIG. 5, a length L1 of the left upper wall 51L in the main scanning direction is smaller than a length L2 of the right upper wall 51R in the main scanning direction. As shown in FIG. 7, the left upper wall 51L is inclined obliquely upward from the upstream side toward the downstream side in the direction in which the recording medium 12 is transported. In other words, the left upper wall 51L is inclined upward from rear to front. As shown in FIG. 8, the right upper wall 51R is inclined obliquely upward from its upstream side toward its downstream side in the direction in which the recording medium 12 is transported. In other words, the right upper wall 51R is inclined upward from rear to front. In the present preferred embodiment, an inclination angle θ1 of the left upper wall 51L with respect to a horizontal direction (refer to FIG. 7) and an inclination angle θ2 (refer to FIG. 8) of the right upper wall 51R with respect to the horizontal direction are the same angle or substantially the same angle. An accommodation container 90, which is described later, is removably attached to the right upper wall 51R.

As shown in FIG. 1, the first left front wall 52L extends obliquely forward and downward from a front end of the left upper wall 51L. The first left front wall 52L includes a first cover 52LA and a second cover 52LB which is able to be opened and closed rotatably about a front end of the left upper wall 51L. The first cover 52LA is located to the left of the second cover 52LB. When the first cover 52LA is opened, four cartridge holders 26 (refer to FIG. 2) are exposed to the outside, for example. When the second cover 52LB is opened, four cartridge holders 26 (refer to FIG. 2) are exposed to the outside. The first right front wall 52R extends obliquely forward and downward from a front end of the right upper wall 51R.

As shown in FIG. 1, the second left front wall 53L extends obliquely forward and downward from a front end of the first left front wall 52L. The second left front wall 53L is located in front of the first cover 52LA. The central wall 53C extends obliquely forward and downward from a front end of a right portion of the first left front wall 52L and a front end of a left portion of the first right front wall 52R. The central wall 53C is located between the second left front wall 53L and the second right front wall 53R. The central wall 53C is located above the platen 15. The second right front wall 53R extends obliquely forward and downward from a front end of the first right front wall 52R. The second right front wall 53R is openable and closable about a front end of the first right front wall 52R. When the second right front wall 53R is opened, an operation panel 18, which is described later, is exposed to the outside. The central wall 53C is provided with a front cover 57 which is rotatable about the central wall 53C. The front cover 57 may be made of any material that allows light to pass through it. In the present preferred embodiment, the front cover 57 is made of a transparent acrylic resin. An operator is able to check printing conditions and so on through the front cover 57. The front cover 57 is provided with a handle 57H. When the operator pulls the handle 57H forward and upward, the front cover 57 is opened.

As shown in FIG. 1, the left front cover 54L extends downward from a front end of the second left front wall 53L. The left front cover 54L is openable and closable about a front end of the second left front wall 53L. The left front cover 54L is located to the left of the platen 15. The right front cover 54R extends downward from a front end of the second right front wall 53R. The right front cover 54R is openable and closable about a front end of the second right front wall 53R. The right front cover 54R is located to the right of the platen 15.

As shown in FIG. 7, the left side wall 55L connects a left end of the left upper wall 51L, a left end of the first left front wall 52L, a left end of the second left front wall 53L, a left end of the left front cover 54L, and a left end of the rear wall 56. As shown in FIG. 8, the right side wall 55R connects a right end of the right upper wall 51R, a right end of the first right front wall 52R, a right end of the second right front wall 53R, a right end of the right front cover 54R, and a right end of the rear wall 56.

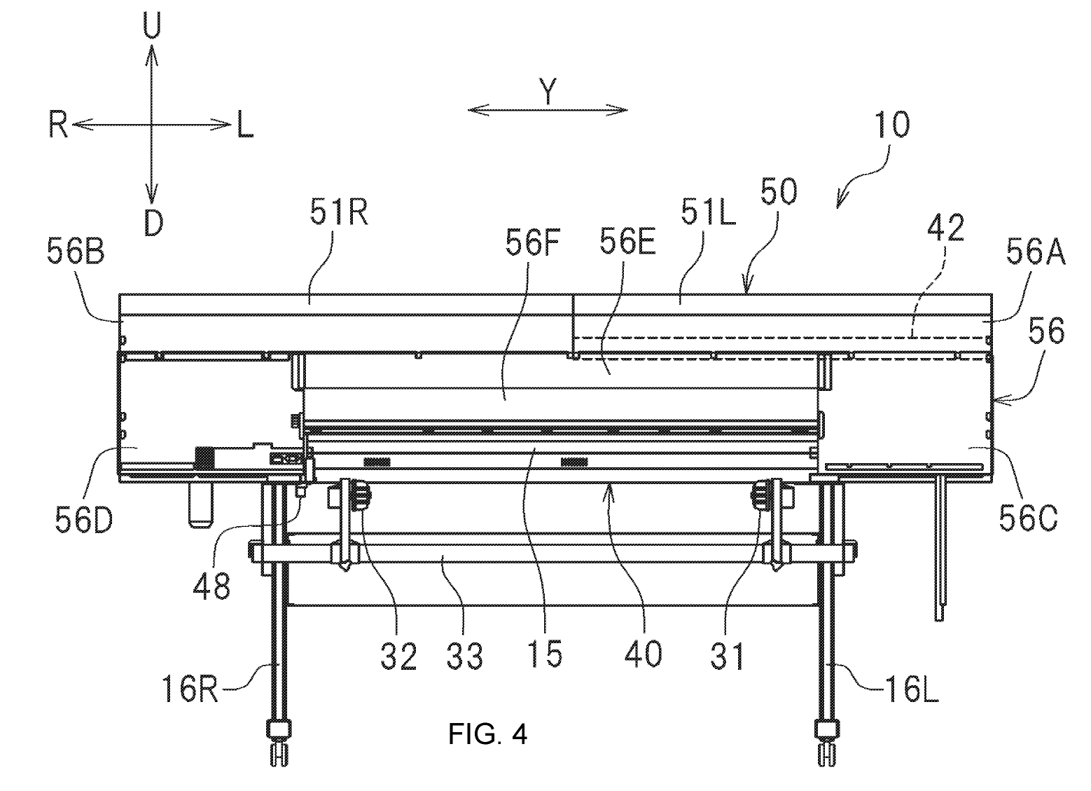

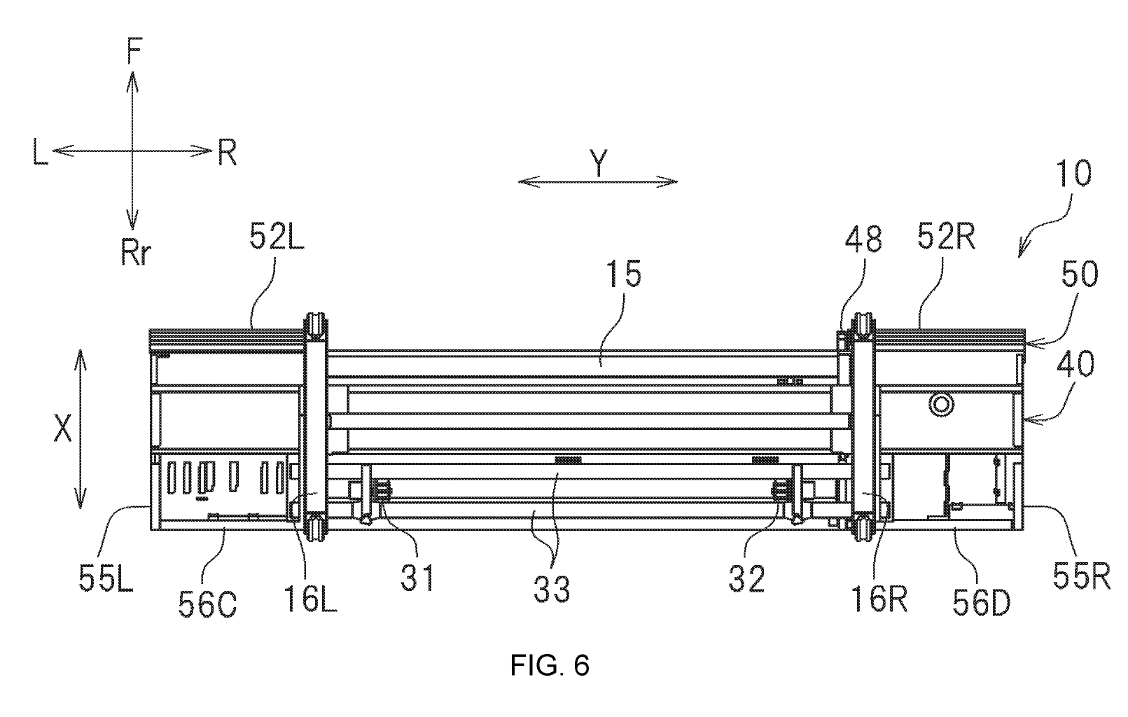

As shown in FIG. 4, the rear wall 56 includes a left upper rear wall 56A, a right upper rear wall 56B, a left lower rear wall 56C, a right lower rear wall 56D, an upper rear central wall 56E, and a lower rear central wall 56F. The left upper rear wall 56A is located below a rear end of the left upper wall 51L. The right upper rear wall 56B is located below a rear end of the right upper wall 51R. The left lower rear wall 56C is located below the left upper rear wall 56A. The left lower rear wall 56C is located at a position opposed to the left front cover 54L (refer to FIG. 2) (refer also to FIG. 6). The right lower rear wall 56D is located below the right upper rear wall 56B. The right lower rear wall 56D is located at a position opposed to the right front cover 54R (refer to FIG. 2) (refer also to FIG. 6). The upper rear central wall 56E extends downward from a lower end of a right portion of the left upper rear wall 56A and a lower end of a left portion of the right upper rear wall 56B. The lower rear central wall 56F is located below the upper rear central wall 56E. The upper rear central wall 56E and the lower rear central wall 56F are located between the left lower rear wall 56C and the right lower rear wall 56D. The upper rear central wall 56E and the lower rear central wall 56F are located above the platen 15. A space through which the recording medium 12 can pass is formed between the upper and lower rear central walls 56E and 56F and the platen 15.

As shown in FIG. 3, the printer 10 includes a guide rail 13 provided on the base 40. The guide rail 13 extends in the main scanning direction Y. The carriage 22 of the ink head unit 20 is in engagement with the guide rail 13. The carriage 22 is reciprocated in the main scanning direction Y along the guide rail 13 by a carriage transfer mechanism 8. The carriage transfer mechanism 8 includes pulleys 19a and 19b located on the left and right end sides, respectively, of the guide rail 13. A carriage motor 8a is coupled to the pulley 19b. The carriage motor 8a may be coupled to the pulley 19a. The pulley 19b is driven by the carriage motor 8a. An endless belt 18 is wrapped around the pulley 19a and the pulley 19b. The carriage 22 is fixed to the belt 18. When the pulley 19a and the pulley 19b are rotated to cause the belt 18 to run, the carriage 22 moves in the main scanning direction Y. In this manner, the carriage 22 is movable in the main scanning direction Y along the guide rail 13. In FIG. 3, the central wall 53C and the cartridge holders 26 are omitted from illustration for convenience of description.

As shown in FIG. 3, the platen 15 is provided at the center of the base 40. The platen 15 is located between the left front cover 54L and the right front cover 54R. The recording medium 12 is placed on the platen 15. The platen 15 extends in the main scanning direction Y. A plurality of grit rollers 17 is provided in the platen 15. The grit rollers 17 are located at positions opposed to pinch rollers (not shown) provided in the base 40. The grit rollers 17 are coupled to a feed motor 17a. The grit rollers 17 are driven for rotation by the feed motor 17a. When the grit rollers 17 are rotated with the recording medium 12 interposed between the grit rollers 17 and the pinch rollers, the recording medium 12 is transported in the sub-scanning direction X.

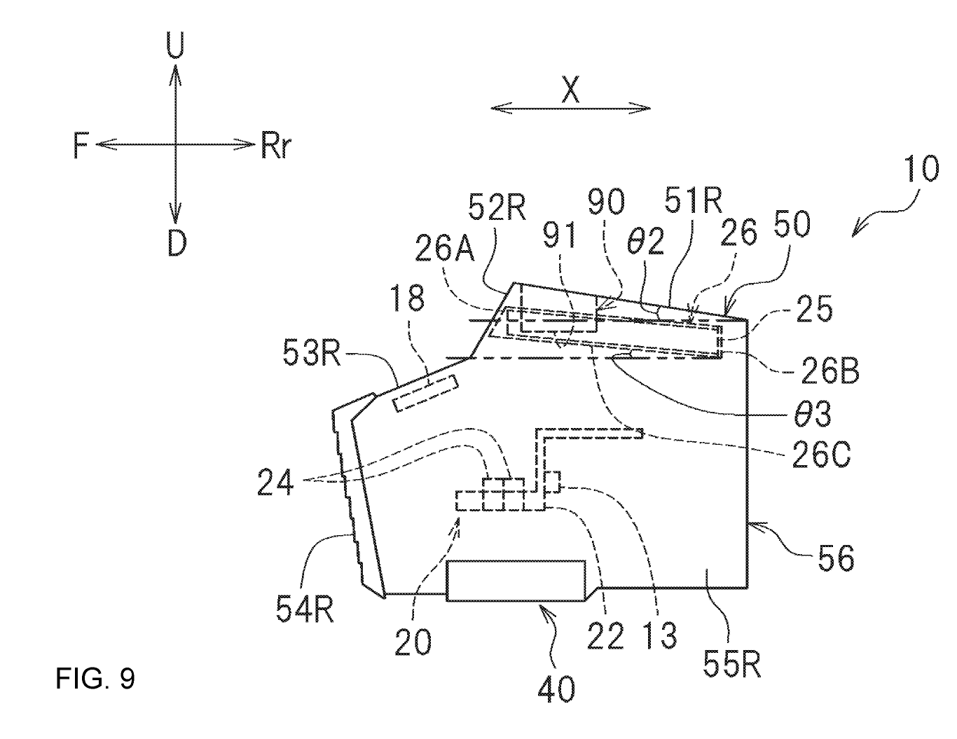

As shown in FIG. 2, the cartridge holders 26 are provided in the main body case 50. The cartridge holders 26 are located above a left portion of the base 40 and below the left upper wall 51L of the main body case 50. More specifically, the cartridge holders 26 are provided on a frame member 42 (refer to FIG. 2) provided on the base 40. The frame member 42 is located above the ink head unit 20. The frame member 42 extends in the main scanning direction Y. The cartridge holders 26 are arranged in the main scanning direction Y. The cartridge holders 26 are located behind the first cover 52LA and the second cover 52LB. As shown in FIG. 9, the cartridge holders 26 are inclined such that front end portions 26A of the cartridge holders 26 are located at higher positions than rear end portions 26B thereof. An inclination angle of the cartridge holders 26 with respect to the horizontal direction is smaller than the inclination angle θ2 of the right upper wall 51R with respect to the horizontal direction. Each cartridge holder 26 removably accommodates an ink cartridge 25 (refer to FIG. 3). The number of the cartridge holders 26, which is eight in the preferred embodiment, for example, is not particularly limited.

Each ink cartridge 25 accommodates an ink pack (not shown) reserving ink in a horizontal position. As shown in FIG. 3, each ink cartridge 25 is removably communicated with one end 62 of an ink passage 60, which is described later. In each ink pack, one of process color inks, such as cyan ink, magenta ink, yellow ink, light cyan ink, light magenta ink and black ink, and special color inks, such as white ink, metallic ink and clear ink, is reserved.

As shown in FIG. 3, the printer 10 includes an ink supply system 35 for each of the ink cartridges 25, in which ink of different colors are reserved. Each ink supply system 35 includes, in addition to the ink cartridge 25, an ink head 24, a damper (not shown), an ink passage 60, a selector valve 64, and a supply pump 68. The ink head 24 and the damper are mounted on the carriage 22, and are reciprocated in the main scanning direction Y. On the other hand, the ink cartridge 25 is not mounted on the carriage 22, and is not reciprocated in the main scanning direction Y. Thus, a major portion of the ink passage 60 (at least over half of the entire length) extends in the main scanning direction Y so that the ink passage 60 cannot be broken when the carriage 22 is moved in the main scanning direction Y. In the present preferred embodiment, a total of eight ink passages 60 are provided, for example. The ink passages 60 are covered with a cable protecting guide device 46.

As shown in FIG. 3, the ink heads 24 are located above the platen 15. In the present preferred embodiment, eight ink heads 24 are mounted on the carriage 22. Each ink head 24 includes a plurality of nozzles 21 to eject the ink accommodated in the ink pack (not shown) in the ink cartridge 25 onto the recording medium 12. The dampers (not shown) are communicated with the ink heads 24 and supply the inks to the ink heads 24. The dampers also play a role of reducing variation in ink pressures. The dampers stabilize the ink ejection operation of the ink heads 24.

As shown in FIG. 3, each ink cartridge 25 and its corresponding ink head 24 are communicated with each other via an ink passage 60. One end 62 of the ink passage 60 is communicated with the ink cartridge 25. The other end 63 of the ink passage 60 is connected to the damper (not shown). The other end 63 of the ink passage 60 is communicated with the ink head 24 via the damper. The ink passage 60 defines a flow path which directs the ink from the ink cartridge 25 to the ink head 24. The ink passage 60 has bendability and flexibility, and is elastically deformable. Although the configuration of the ink passage 60 is not particularly limited, it is a resin tube which is easily deformable in the present preferred embodiment. However, the ink passage 60 may be formed of a material other than a tube. A portion of the ink passage 60 may be defined by a tube.

As shown in FIG. 3, the selector valves 64 are located in the ink passages 60. The selector valves 64 are provided between the ink cartridges 25 and the supply pumps 68. The selector valves 64 are located in the main body case 50. The selector valves 64 are located below the cartridge holders 26. The selector valves 64 are located behind the left front cover 54L and on the left lower rear wall 56C (refer to FIG. 4). Each selector valve 64 is able to open and close its corresponding ink passage 60. When the selector valve 64 opens the ink passage 60, the ink reserved in the ink pack accommodated in the ink cartridge 25 is able to be supplied to the ink head 24. On the other hand, when the selector valve 64 closes the ink passage 60, the ink reserved in the ink pack accommodated in the ink cartridge 25 cannot be supplied to the ink head 24.

As shown in FIG. 3, the supply pumps 68 are provided in the ink passages 60. The supply pumps 68 are located between the selector valves 64 and the ink heads 24. The supply pumps 68 are located in the main body case 50. The supply pumps 68 are located below the cartridge holders 26. The supply pumps 68 are located behind the left front cover 54L and on the left lower rear wall 56C (refer to FIG. 4). The supply pumps 68 are able to supply (feed) the inks from the ink cartridges 25 to the ink heads 24. The supply pumps 68 in the present preferred embodiment are, but not limited to, pressure pumps. The supply pumps 68 may be tube pumps, for example.

As shown in FIG. 1, the operation panel 18 is provided below the second right front wall 53R of the main body case 50. The operation panel 18 is located upstream of the right front cover 54R in the direction in which the recording medium 12 is transported. In the present preferred embodiment, the operation panel 18 is located behind the right front cover 54R. The operation panel 18 includes a display on which the conditions of the printer are displayed, input keys that are operated by the operator, and so on. The operation panel 18 is connected to a controller 30 (refer to FIG. 3) that controls various operations of the printer 10.

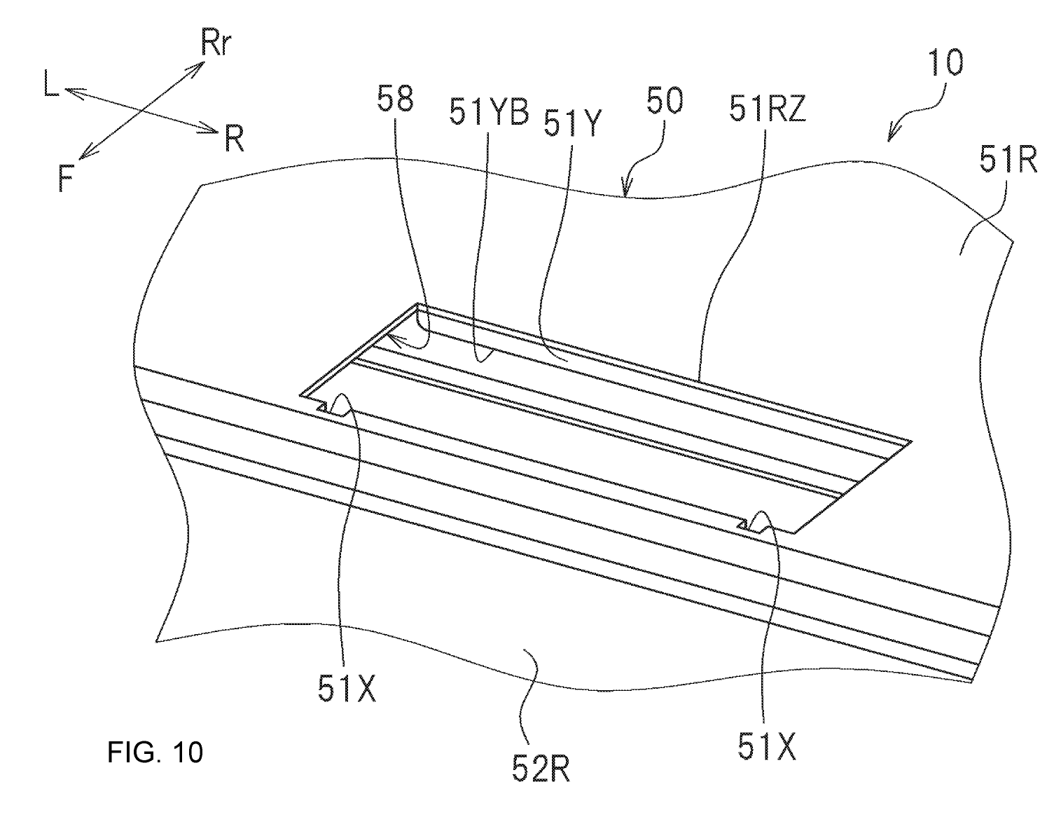

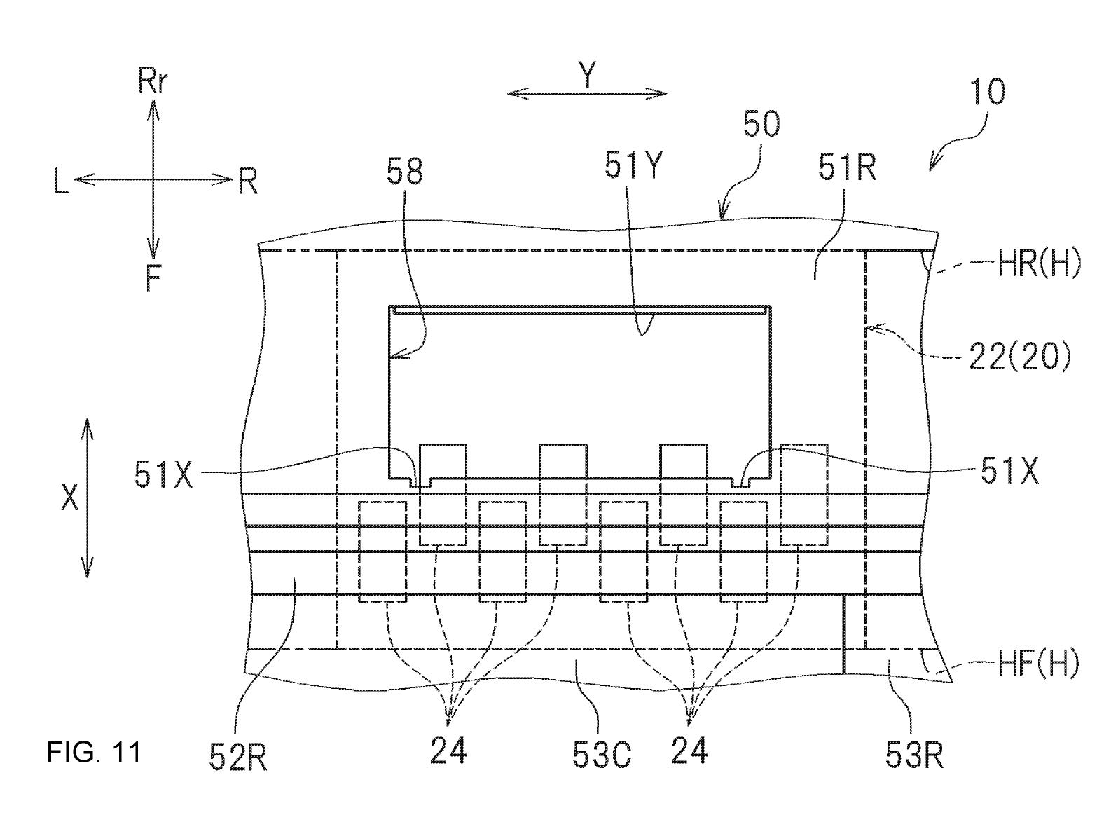

As shown in FIG. 10, a through hole 58 extends through the right upper wall 51R of the main body case 50. The through hole 58 preferably has a rectangular shape, for example. As shown in FIG. 5, the through hole 58 overlaps with a movement path H of the carriage 22 as viewed in a plan view. More specifically, the through hole 58 is located in front of a movement path HR of a rear end 22R of the carriage 22 and behind a movement path HF of a front end 22F of the carriage 22 as viewed in a plan view. The through hole 58 is located at a position that overlaps with the platen 15 as viewed in a plan view. The through hole 58 is located to the right of a middle position C1 between a left end of the left upper wall 51L and a right end of the right upper wall 51R. The through hole 58 is located on the operation panel 18 side of a middle position C2 between a left end of the platen 15 and a right end of the platen 15. The through hole 58 is located to the right of the middle position C2. The through hole 58 is located to the left of the operation panel 18. The through hole 58 is located to the left of the right front cover 54R. The through hole 58 is located generally at the center of the right upper wall 51R in the main scanning direction Y. The through hole 58 is located on the downstream side of a middle position C3 between a first end portion 51RR of the right upper wall 51R on the upstream side in the direction in which the recording medium 12 is transported and a second end portion 51RF of the right upper wall 51R on the downstream side in the direction in which the recording medium 12 is transported. The first end portion 51RR corresponds to a rear end of the right upper wall 51R. The second end portion 51RF corresponds to a front end of the right upper wall 51R. As shown in FIG. 11, when the carriage 22 is positioned below the through hole 58, the through hole 58 overlaps with some portions of the ink heads 24 as viewed in a plan view. In other words, the operator is able to check the conditions of the ink heads 24 and components or elements around them mounted on the carriage 22 through the through hole 58.

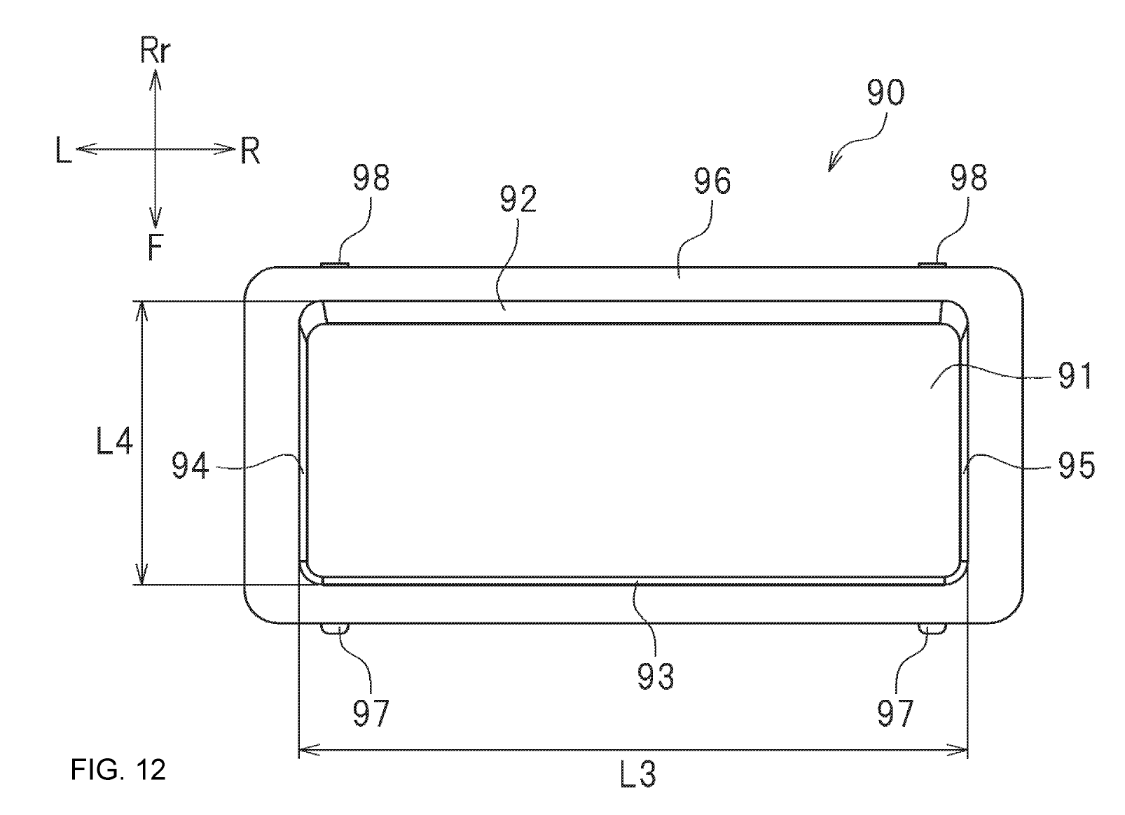

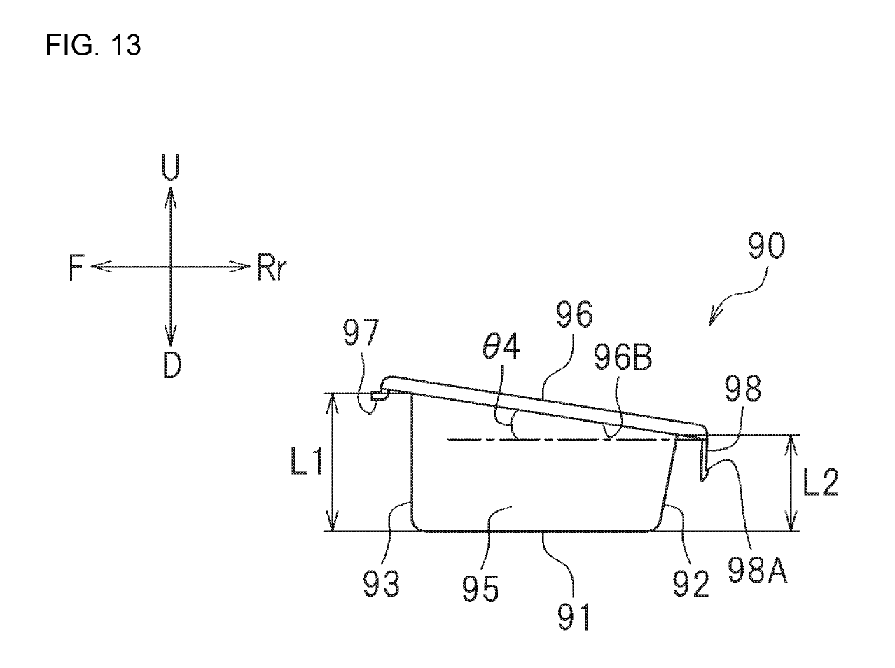

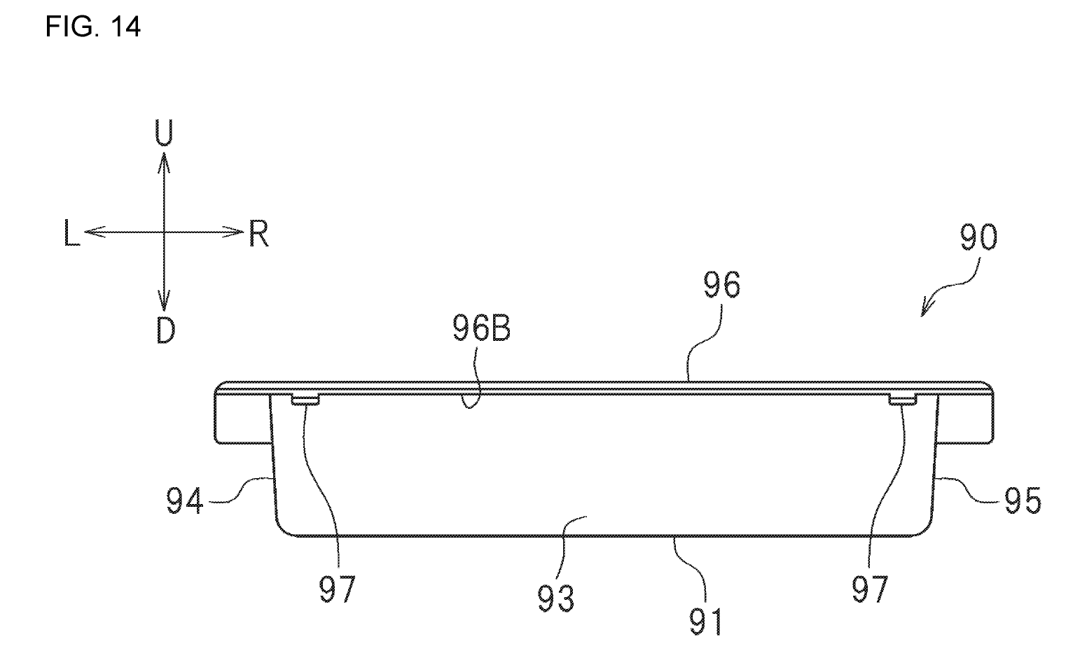

As shown in FIG. 1, the accommodation container 90 is removably provided in the through hole 58 extending through the right upper wall 51R. The accommodation container 90 is made of an elastic resin material. In the present preferred embodiment, the accommodation container 90 is made of an ABS resin. The accommodation container 90 opens upward. The accommodation container 90 preferably has a recessed shape that is recessed downward from the right upper wall 51R. FIG. 12 is a plan view of the accommodation container 90. FIG. 13 is a right side view of the accommodation container 90. FIG. 14 is a front view of the accommodation container 90.

As shown in FIG. 12, the accommodation container 90 includes a bottom wall 91, a rear wall 92, a front wall 93, a left wall 94, a right wall 95, and top wall 96. Each of the rear wall 92, the front wall 93, the left wall 94 and the right wall 95 is one example of a side wall that extends upward from a peripheral edge of the bottom wall 91. As shown in FIG. 13, the bottom wall 91 extends in the horizontal direction. The rear wall 92 extends upward from a rear end of the bottom wall 91. The rear wall 92 is one example of a first wall. The front wall 93 is located at a position opposed to the rear wall 92. The front wall 93 extends upward from a front end of the bottom wall 91. A length L1 of the front wall 93 in a vertical direction is longer than a length L2 of the rear wall 92 in a vertical direction. The front wall 93 is one example of a second wall. As shown in FIG. 12, the left wall 94 is located at a position perpendicular to the rear wall 92. The left wall 94 extends upward from a left end of the bottom wall 91. The left wall 94 is one example of a third wall. The right wall 95 is located at a position opposed to the left wall 94. The right wall 95 extends upward from a right end of the bottom wall 91. The right wall 95 and the left wall 94 are laterally symmetrical with each other. The right wall 95 is one example of a fourth wall. A length L3 of the rear wall 92 and the front wall 93 in a right-left direction is longer than a length L4 of the left wall 94 and the right wall 95 in a front-rear direction. An accommodation space in which attachments, etc., is able to be accommodated is defined by the bottom wall 91, the rear wall 92, the front wall 93, the left wall 94 and the right wall 95. The top wall 96 extends outward from an upper end of the rear wall 92, an upper end of the front wall 93, an upper end of the left wall 94 and an upper end of the right wall 95. As shown in FIG. 13, the top wall 96 is inclined obliquely upward from the rear wall 92 to the front wall 93. An inclination angle 64 of the top wall 96 with respect to the horizontal direction (refer to FIG. 13) is the same as the inclination angle 62 of the right upper wall 51R with respect to the horizontal direction (refer to FIG. 8). The top wall 96 is one example of a fifth wall.

As shown in FIG. 12, the accommodation container 90 includes a pair of locking tabs 97 (refer also to FIG. 14), and a pair of engaging tabs 98. The paired locking tabs 97 are arranged in a right-left direction. The paired engaging tabs 98 are arranged in a right-left direction. As shown in FIG. 13, the locking tabs 97 and the engaging tabs 98 are formed on the top wall 96. The locking tabs 97 extend forward from a lower surface 96B of the top wall 96. The locking tabs 97 are located in front of the front wall 93. The locking tabs 97 are inserted into cutout portions 51X (refer to FIG. 10) located in the right upper wall 51R and locked on a reverse side of the right upper wall 51R when the accommodation container 90 is attached in the through hole 58. Each cutout portions 51X is a portion of the through hole 58.

As shown in FIG. 13, the engaging tabs 98 extend downward from the lower surface 96B of the top wall 96. The engaging tabs 98 are located behind the rear wall 92. The engaging tabs 98 are engaged with a vertical wall 51Y provided on the right upper wall 51R (refer to FIG. 10) via snap-fit engagement when the accommodation container 90 is attached in the through hole 58. At this time, a stepped portion 98A of each engaging tab 98 is engaged with a lower end 51YB of the vertical wall 51Y (refer to FIG. 10). The vertical wall 51Y extends downward from a portion 51RZ that defines a rear edge of the through hole 58 in the right upper wall 51R. When the accommodation container 90 is attached in the through hole 58, the locking tabs 97 of the accommodation container 90 are first inserted into the cutout portions 51X, and then the engaging tabs 98 are engaged with the vertical wall 51Y.

As shown in FIG. 9, when the accommodation container 90 has been attached in the through hole 58 (refer to FIG. 1), a portion of the accommodation container 90 overlaps with the cartridge holders 26 as viewed in a side view. When the accommodation container 90 has been attached in the through hole 58, a portion of the accommodation container 90 overlaps with the ink cartridges 25 as viewed in a side view. The bottom wall 91 of the accommodation container 90 is located above bottom walls 26C of the cartridge holders 26. The bottom wall 91 of the accommodation container 90 may be located below the bottom walls 26C of the cartridge holders 26.

As shown in FIG. 1, the printer 10 includes a loading lever 48. The loading lever 48 is provided on the base 40. The loading lever 48 is provided to the left of the right front cover 54R. The loading lever 48 protrudes forward from the platen 15. The loading lever 48 is located to the right of the through hole 58. The loading lever 48 is coupled to the pinch rollers. By operating the loading lever 48, it is possible to move the pinch rollers toward and away from the grit rollers 17 (refer to FIG. 3) and pinch the recording medium 12 between the pinch rollers and the grit rollers 17.

As shown in FIG. 4, the printer 10 includes a first holder 31 and a second holder 32 that hold the recording medium 12 for rotation in a roll form. The first holder 31 is located to the left of the second holder 32. The first holder 31 and the second holder 32 are located behind the platen 15. The first holder 31 and the second holder 32 are located below the main body case 50. The first holder 31 and the second holder 32 are disposed slidably on a slide bar 33 extending in the main scanning direction Y. The positions of the first holder 31 and the second holder 32 in the main scanning direction Y are able to be changed along the slide bar 33. The slide bar 33 is supported by the left leg portion 16L and the right leg portion 16R.

As described above, according to the printer 10 of the present preferred embodiment, the through hole 58 extends through the right upper wall 51R of the main body case 50, and the accommodation container 90 is removably attached in the through hole 58. The through hole 58 is located at a position that overlaps with the movement path H of the carriage 22 as viewed in a plan view. Thus, when the accommodation container 90 provided in the through hole 58 is removed at the time of maintenance or the like, the operator is able to check the conditions of components or elements, such as the ink heads 24, mounted on the carriage 22 through the through hole 58, and is able to easily access the components or elements through the through hole 58. In addition, because the accommodation container 90 provided in the through hole 58 opens upward, the operator is able to easily manage attachments, etc. and is able to easily access the attachments, etc., by accommodating them in the accommodation container 90.

According to the printer 10 of the present preferred embodiment, the right upper wall 51R is obliquely inclined upward from the upstream side to the downstream side in the direction in which the recording medium 12 is transported. When the right upper wall 51R is inclined in such a manner, attachments, etc. cannot be placed on the right upper wall 51R. However, because the accommodation container 90 is provided in the through hole 58 extending through the right upper wall 51R, the operator is able to manage attachments, etc. by accommodating them in the accommodation container 90 irrespective of the right upper wall 51R being inclined.

According to the printer 10 of the present preferred embodiment, the accommodation container 90 includes the bottom wall 91, which extends in the horizontal direction. If the bottom wall 91 of the accommodation container 90 is inclined in the same manner as the right upper wall 51R of the main body case 50, it may be difficult to take out attachments, etc. accommodated in the accommodation container 90. However, because the bottom wall 91 of the accommodation container 90 is horizontal, attachments, etc. are able to be taken out easily.

According to the printer 10 of the present preferred embodiment, the accommodation container 90 is made of an elastic resin material. The accommodation container 90 includes the engaging tabs 98, which are provided on the top wall 96 and are able to engage with the right upper wall 51R around the through hole 58 via snap-fit engagement when the accommodation container 90 is attached in the through hole 58. In this way, because the accommodation container 90 is able to be fitted in the through hole 58 and attached to the right upper wall 51R without the need for screws or the like, a simple structure with a small number of components or elements is able to be achieved.

According to the printer 10 of the present preferred embodiment, the through hole 58 overlaps with the platen 15 as viewed in a plan view. Usually, cleaning mechanism for maintenance of the ink heads 24 and so on are provided to the left or right of the platen 15, and it should be avoided to perform any maintenance work above them. On the other hand, the platen 15 has a surface with a simpler structure. Thus, even when a component or element mounted on the carriage 22 is dropped onto the platen 15 during its maintenance, the influence on the platen 15 is relatively small and the possibility of new problems occurring is relatively small.

According to the printer 10 of the present preferred embodiment, the cartridge holders 26 are located above the left side of the base 40, and the accommodation container 90 is located above the right side of the base 40. A portion of the accommodation container 90 overlaps with the cartridge holders 26 as viewed in a side view. The cartridge holders 26, which require some space in a vertical direction, are located only above the left side of the base 40. Thus, positioning the accommodation container 90 above the right side of the base 40 allows effective use of space to ensure that the accommodation container 90 has a sufficient capacity.

According to the printer 10 of the present preferred embodiment, the through hole 58 is located in front of the middle position C3 between the rear end 51RR of the right upper wall 51R and the front end 51RF of the right upper wall 51R. This configuration allows the operator to access attachments, etc. accommodated in the accommodation container 90 easily.

According to the printer 10 of the present preferred embodiment, the through hole 58 is located on the operation panel 18 side of the middle position C2 between a left end portion of the platen 15 and a right end portion of the platen 15 in the main scanning direction Y. Because the operator often stands in the vicinity of the operation panel 18 during work, positioning the through hole 58 on the operation panel 18 side allows the operator to access attachments, etc., accommodated in the accommodation container 90 more easily.

In the foregoing, preferred embodiments of the present invention have been described. However, each of the above preferred embodiments is for illustrative purposes only and the present invention can be implemented in various other forms.

While the through hole 58 extends through the right upper wall 51R and the cartridge holders 26 are located below the left upper wall 51L in the above preferred embodiments, the present invention is not limited to this configuration. The cartridge holders 26 may be located below the right upper wall 51R, and the through hole 58 may extend through the left upper wall 51L.

While the through hole 58 overlaps with a movement path of the carriage as viewed in a plan view in the above preferred embodiments, the present invention is not limited to this configuration. The through hole 58 does not have to overlap with a movement path of the carriage, and instead may be a partial through hole or may partially overlap. The through hole 58 and the cartridge holders 26 may slip off in the direction in which the recording medium 12 is transported.

While the right upper wall 51R and the left upper wall 51L are inclined upward from rear to front in the above preferred embodiment, the present invention is not limited to this configuration. The right upper wall 51R and the left upper wall 51L may extend in the horizontal direction or may be inclined downward from rear to front.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet printer, comprising:
a base including a platen on which a recording medium is placed;
a carriage provided on the base and movable in a main scanning direction;
an ink head mounted on the carriage and including a nozzle to eject ink onto the recording medium that is transported from an upstream side to a downstream side;
a main body case attached to the base and including an upper wall located at least above the carriage; and
an accommodation container including a bottom wall and a side wall extending upward from a peripheral edge of the bottom wall and opening upward; wherein
the upper wall includes a through hole that overlaps with a movement path of the carriage as viewed in a plan view; and
the accommodation container is removably provided in the through hole such that the accommodation container is exposed to an outside.

2. The inkjet printer according to claim 1, wherein the accommodation container closes an entirety of the through hole when the accommodation container is provided in the through hole.

3. The inkjet printer according to claim 1, wherein the upper wall is inclined obliquely upward from the upstream side to the downstream side.

4. The inkjet printer according to claim 1, wherein
the bottom wall extends in a horizontal direction;
the side wall includes a first wall extending upward from an end portion of the bottom wall on the upstream side, a second wall opposed to the first wall and extending upward from an end portion of the bottom wall on the downstream side, a third wall perpendicular to the first wall and extending upward from an end portion of the bottom wall on a first side in the main scanning direction, and a fourth wall opposed to the third wall and extending upward from an end portion of the bottom wall on a second side in the main scanning direction; and
the accommodation container includes a fifth wall extending outward of the accommodation container from an upper end of the first wall, an upper end of the second wall, an upper end of the third wall and an upper end of the fourth wall and having a same inclination angle or substantially a same inclination angle as the upper wall.

5. The inkjet printer according to claim 1, wherein
the bottom wall extends in a horizontal direction;
the side wall includes a first wall extending upward from an end portion of the bottom wall on the upstream side, a second wall opposed to the first wall and extending upward from an end portion of the bottom wall on the downstream side, a third wall perpendicular to the first wall and extending upward from an end portion of the bottom wall on a first side in the main scanning direction, and a fourth wall opposed to the third wall and extending upward from an end portion of the bottom wall on a second side in the main scanning direction; and
the accommodation container includes a fifth wall extending outward of the accommodation container from an upper end of the first wall, an upper end of the second wall, an upper end of the third wall and an upper end of the fourth wall and having a same inclination angle or substantially a same inclination angle as the upper wall;
the accommodation container is made of an elastic resin material and includes an engaging tab that is able to engage with the upper wall around the through hole via snap-fit engagement when the accommodation container is attached in the through hole; and
the engaging tab is located on the fifth wall.

6. The inkjet printer according to claim 1, wherein the through hole overlaps with the platen as viewed in a plan view.

7. The inkjet printer according to claim 1, further comprising a cartridge holder located above a first side of the base in the main scanning direction and below the upper wall and accommodating an ink cartridge containing ink to be supplied to the ink head; wherein
the accommodation container is located above a second side of the base in the main scanning direction; and
a portion of the accommodation container overlaps with the cartridge holder as viewed in a side view.

8. The inkjet printer according to claim 1, wherein the through hole is located on the downstream side of a middle position between a first end portion of the upper wall on the upstream side and a second end portion of the upper wall on the downstream side.

9. An inkjet printer, comprising:
a base including a platen on which a recording medium is placed;
a carriage provided on the base and movable in a main scanning direction;
an ink head mounted on the carriage and including a nozzle to eject ink onto the recording medium that is transported from an upstream side to a downstream side;
a main body case attached to the base and including an upper wall located at least above the carriage; and
an accommodation container including a bottom wall and a side wall extending upward from a peripheral edge of the bottom wall and opening upward; wherein
the upper wall includes a through hole that overlaps with a movement path of the carriage as viewed in a plan view; and
the accommodation container is removably provided in the through hole such that the accommodation container is above the carriage.

10. The inkjet printer according to claim 9, wherein the accommodation container closes an entirety of the through hole when the accommodation container is provided in the through hole.

11. The inkjet printer according to claim 9, wherein the upper wall is inclined obliquely upward from the upstream side to the downstream side.

12. The inkjet printer according to claim 9, wherein
the bottom wall extends in a horizontal direction;
the side wall includes a first wall extending upward from an end portion of the bottom wall on the upstream side, a second wall opposed to the first wall and extending upward from an end portion of the bottom wall on the downstream side, a third wall perpendicular to the first wall and extending upward from an end portion of the bottom wall on a first side in the main scanning direction, and a fourth wall opposed to the third wall and extending upward from an end portion of the bottom wall on a second side in the main scanning direction; and
the accommodation container includes a fifth wall extending outward of the accommodation container from an upper end of the first wall, an upper end of the second wall, an upper end of the third wall and an upper end of the fourth wall and having a same inclination angle or substantially a same inclination angle as the upper wall.

13. The inkjet printer according to claim 9, wherein
the bottom wall extends in a horizontal direction;
the side wall includes a first wall extending upward from an end portion of the bottom wall on the upstream side, a second wall opposed to the first wall and extending upward from an end portion of the bottom wall on the downstream side, a third wall perpendicular to the first wall and extending upward from an end portion of the bottom wall on a first side in the main scanning direction, and a fourth wall opposed to the third wall and extending upward from an end portion of the bottom wall on a second side in the main scanning direction; and
the accommodation container includes a fifth wall extending outward of the accommodation container from an upper end of the first wall, an upper end of the second wall, an upper end of the third wall and an upper end of the fourth wall and having a same inclination angle or substantially a same inclination angle as the upper wall;
the accommodation container is made of an elastic resin material and includes an engaging tab that is able to engage with the upper wall around the through hole via snap-fit engagement when the accommodation container is attached in the through hole; and
the engaging tab is located on the fifth wall.

14. The inkjet printer according to claim 9, wherein the through hole overlaps with the platen as viewed in a plan view.

15. The inkjet printer according to claim 9, further comprising a cartridge holder located above a first side of the base in the main scanning direction and below the upper wall and accommodating an ink cartridge containing ink to be supplied to the ink head; wherein
the accommodation container is located above a second side of the base in the main scanning direction; and
a portion of the accommodation container overlaps with the cartridge holder as viewed in a side view.

16. The inkjet printer according to claim 9, wherein the through hole is located on the downstream side of a middle position between a first end portion of the upper wall on the upstream side and a second end portion of the upper wall on the downstream side.

17. An inkjet printer, comprising:
a base including a platen on which a recording medium is placed;
a carriage provided on the base and movable in a main scanning direction;
an ink head mounted on the carriage and including a nozzle to eject ink onto the recording medium that is transported from an upstream side to a downstream side;
a main body case attached to the base and including an upper wall located at least above the carriage; and
an accommodation container including a bottom wall and a side wall extending upward from a peripheral edge of the bottom wall and opening upward; wherein
the main body case includes an openable and closable first cover provided on a first side of the platen in the main scanning direction, an openable and closable second cover provided on a second side of the platen in the main scanning direction, and an operation panel provided on the upstream side of the second cover; and
the through hole is located on an operation panel side of a middle position between an end portion of the platen on a first side in the main scanning direction and an end portion of the platen on a second side in the main scanning direction.

18. The inkjet printer according to claim 17, wherein the accommodation container closes an entirety of the through hole when the accommodation container is provided in the through hole.

19. The inkjet printer according to claim 17, wherein the upper wall is inclined obliquely upward from the upstream side to the downstream side.

20. The inkjet printer according to claim 17, wherein
the bottom wall extends in a horizontal direction;
the side wall includes a first wall extending upward from an end portion of the bottom wall on the upstream side, a second wall opposed to the first wall and extending upward from an end portion of the bottom wall on the downstream side, a third wall perpendicular to the first wall and extending upward from an end portion of the bottom wall on a first side in the main scanning direction, and a fourth wall opposed to the third wall and extending upward from an end portion of the bottom wall on a second side in the main scanning direction; and
the accommodation container includes a fifth wall extending outward of the accommodation container from an upper end of the first wall, an upper end of the second wall, an upper end of the third wall and an upper end of the fourth wall and having a same inclination angle or substantially a same inclination angle as the upper wall.

21. The inkjet printer according to claim 17, wherein
the bottom wall extends in a horizontal direction;
the side wall includes a first wall extending upward from an end portion of the bottom wall on the upstream side, a second wall opposed to the first wall and extending upward from an end portion of the bottom wall on the downstream side, a third wall perpendicular to the first wall and extending upward from an end portion of the bottom wall on a first side in the main scanning direction, and a fourth wall opposed to the third wall and extending upward from an end portion of the bottom wall on a second side in the main scanning direction; and
the accommodation container includes a fifth wall extending outward of the accommodation container from an upper end of the first wall, an upper end of the second wall, an upper end of the third wall and an upper end of the fourth wall and having a same inclination angle or substantially a same inclination angle as the upper wall;
the accommodation container is made of an elastic resin material and includes an engaging tab that is able to engage with the upper wall around the through hole via snap-fit engagement when the accommodation container is attached in the through hole; and
the engaging tab is located on the fifth wall.

22. The inkjet printer according to claim 17, wherein the through hole overlaps with the platen as viewed in a plan view.

23. The inkjet printer according to claim 17, further comprising a cartridge holder located above a first side of the base in the main scanning direction and below the upper wall and accommodating an ink cartridge containing ink to be supplied to the ink head; wherein
the accommodation container is located above a second side of the base in the main scanning direction; and
a portion of the accommodation container overlaps with the cartridge holder as viewed in a side view.

24. The inkjet printer according to claim 17, wherein the through hole is located on the downstream side of a middle position between a first end portion of the upper wall on the upstream side and a second end portion of the upper wall on the downstream side.
